(19) United States
(12) Patent Application Publication
(10) Pub. No.: US 2026/0185501 A1
(43) Pub. Date: Jul. 2, 2026

(54) FORCE DEFLECTION ARRANGEMENT

(71) Applicant: Felix ISAAC, Greater London (GB)

(72) Inventor: Felix ISAAC, Greater London (GB)

(21) Appl. No.: 19/126,561

(22) PCT Filed: Nov. 1, 2023
(86) PCT No.: PCT/EP2023/080481

§ 371 Date: May 1, 2025

(30) Foreign Application Priority Data
Nov. 1, 2022 (GB) 2216180.6

(51) Int. Cl. F03B 17/02

(52) U.S. Cl. CPC F03B 17/02; F05B 2270/602

(57) ABSTRACT

An apparatus including: a container housing a body immersed in a fluid; at least one actuator configured to cause the body to move within the fluid to deflect about an equilibrium position of the body within the fluid, wherein when the body is not at its equilibrium position, hydrostatic pressure from the fluid acts to cause the body to return to its equilibrium position; and at least one connector connecting the container to an output shaft; wherein when the hydrostatic pressure is acting to cause the body to return to its equilibrium position, the container and the at least one connector are caused to at least partially rotate about an axis, wherein the at least partial rotation causes the output shaft to rotate.

### FIELD

The present invention relates to a device that uses hydrostatic pressure from a contained liquid comprising an immersed floatation body to cause the hydrostatic pressure to the floatation body to move the container, and to harness the movement of the container to cause continuous rotation of a shaft.

### BACKGROUND

In these times, there is a desire to reduce the usage of fossil fuels for generating electricity and to instead increase electricity generation from renewable electricity mechanisms.

The following discloses an apparatus for generating electricity from a combination of mechanical and hydrostatic forces.

It is understood that a volume of liquid kept within a container will subject the surface of the container to hydrostatic pressure. Similarly, a body that is immersed in a volume of liquid will also be subjected to hydrostatic pressure.

Typically, a volume of liquid kept within a container does not cause the container to repeatedly move from one point to another point similarly a body that is immersed in a volume of liquid will not cause the container of the liquid to repeatedly move from one point to another point.

### SUMMARY

The present invention is defined by the appended independent claims. Certain more specific aspects are defined by the dependent claims.

### DESCRIPTION OF FIGURES

The invention will now be described solely by way of example and with reference to the accompanying drawings in which:

FIG. 1A shows a front isometric view of the container exploded the contained liquid is not shown;

FIG. 1B shows a back isometric view of that shown in FIG. 1A; and

FIG. 2 shows a back isometric view of the body exploded; and

FIG. 3 shows a front isometric view of the container attached to the means by which it may swing about an axis and set within the partially exploded housing; and

FIG. 4 shows a front isometric view of the body part of the container attached to the means by which it may swing about an axis part of the housing; and

FIG. 5A shows a front isometric view of part of the body part of the container attached to part of the means by which it may swing about an axis part of the mechanism to separately interact with the body; and

FIG. 5B shows a back isometric view of that shown in FIG. 5A; and

FIG. 6A shows a front isometric view of part of the body part of the container attached to part of the means by which it may swing about an axis part of the mechanism to separately interact with the body means by which to arrest the motion of the container; and

FIG. 6B shows a back isometric view of that shown in FIG. 6A; and

FIG. 7A shows a front isometric view of part of the body part of the container attached to part of the means by which it may swing about an axis part of the mechanism to separately interact with the body means by which to arrest the motion of the container means by which to detect the location of the container; and

FIG. 7B shows a back isometric view of that shown in FIG. 7A; and

FIG. 7C shows a back view of that shown in FIG. 7A; and

FIG. 8A shows a front isometric view of part of the body part of the container attached to part of the means by which it may swing about an axis part of the mechanism to separately interact with the body means by which to arrest the motion of the container means by which to detect the location of the container; and

FIG. 8B shows a back isometric view of that shown in FIG. 8A; and

FIG. 8C shows a back view of that shown in FIG. 8A; and

FIG. 9A shows a front isometric view of part of the body part of the container attached to part of the means by which it may swing about an axis part of the mechanism to separately interact with the body means by which to arrest the motion of the container; and

FIG. 9B shows a back isometric view of that shown in FIG. 9A; and

FIG. 9C shows a back view of that shown in FIG. 9A; and

FIG. 10A shows a front isometric view of part of the housing the mechanism to separately interact with the body; and

FIG. 10B shows a front view of that shown in FIG. 10A; and

FIG. 11A shows a front isometric view of part of the housing part of the mechanism to separately interact with the body; and

FIG. 11B shows a front view of that shown in FIG. 11A; and

FIG. 12 shows a front isometric view of part of the means by which the shaft is made to rotate; and

FIG. 13A shows a front isometric view of the means by which the shaft is made to rotate; and

FIG. 13B shows a back isometric view of that shown in FIG. 13A; and

FIG. 14A shows a front isometric view of part of the housing part of the means by which the shaft is made to rotate; and

FIG. 14B shows a back isometric view of that shown in FIG. 14A; and

FIG. 15 shows a front isometric view of the container part of the housing and the electric generator.

### DETAILED DESCRIPTION

The following discloses the use of hydrostatic pressure to output a rotational force to a shaft that can be used to drive machinery. The shaft can be used to drive an electricity generator, and/or to generally power another machine (e.g., a motor). The output of this shaft may therefore be used to reduce reliance on the usage of fossil fuels to perform such tasks.

In more detail, there is disclosed a container that comprises a body immersed in a fluid (e.g., a liquid). Stated differently, there is provided a container comprising a fluid and a body. The body may be less dense that the surrounding fluid. The body may be configured to rotate within the container. The body may be configured such that rotation of the body causes rotation of the container.

The body may, via hydrostatic pressure from the surrounding fluid, be caused to act to return to an equilibrium position within the container. Stated differently, in the absence of any other external force on the body, the body may be biased to return to the equilibrium position. This equilibrium position may therefore be considered to be a neutral position. The body may be biased to return to the equilibrium position as a result of the hydrostatic pressure of the fluid on the body as a result of the difference in density between the body and the fluid.

In the presently described system, the body is caused to move between a first position (on a first side of the equilibrium position) and a second position (on a second side of the equilibrium position, the second side being opposite to the first side). Stated differently, the body is caused to rotate about the equilibrium position. The body may be caused to move between the first and second positions by the actions of an actuator. In the example described below, the actuator is described as comprising a first actuator and a second actuator whose movements are controlled by respective solenoids. However, it is understood that this is not limiting and that other types of actuators may be provided to cause the body to move between the first and second positions.

At each of the first and second positions, the body is configured to be caused to return to the equilibrium position (e.g., as a result of the hydrostatic force on the body). The body may be prevented from returning to the equilibrium positions by at least respective pointer. This prevention may cause a resultant rotation force from the effect of the hydrostatic force to be transferred to the container, which causes the container to swing about an axis.

The container is connected to an output shaft via a connector (e.g., via spokes in the example of the Figures). Therefore, the back-and-forth swinging motion of the container that results from the body moving between the first and second positions (and the change in direction of the action of the hydrostatic force) causes the connector to cause the output shaft to rotate in a single direction. The output shaft may be subsequently used to power a generator and/or to function as a motor to another apparatus.

Stated differently, in the following, the container is made to repeatedly move from one point to another point due to the hydrostatic pressure on the container. The container is also made to repeatedly move from one point to another point due to the hydrostatic pressure on the immersed body.

In the presently described system, the repeated movement of the container is harnessed to cause the rotation of a shaft. The rotation of the shaft is used to drive an electric generator the rotation of the shaft may also be used to drive alternative devices or machinery (e.g., as a motor).

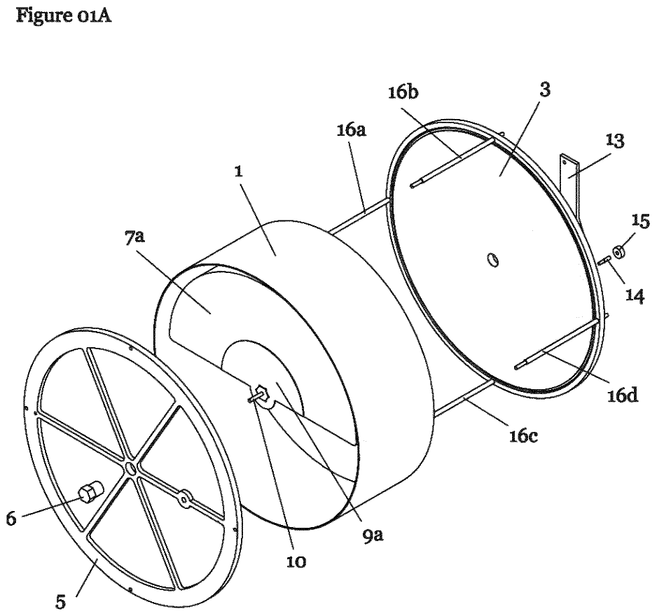

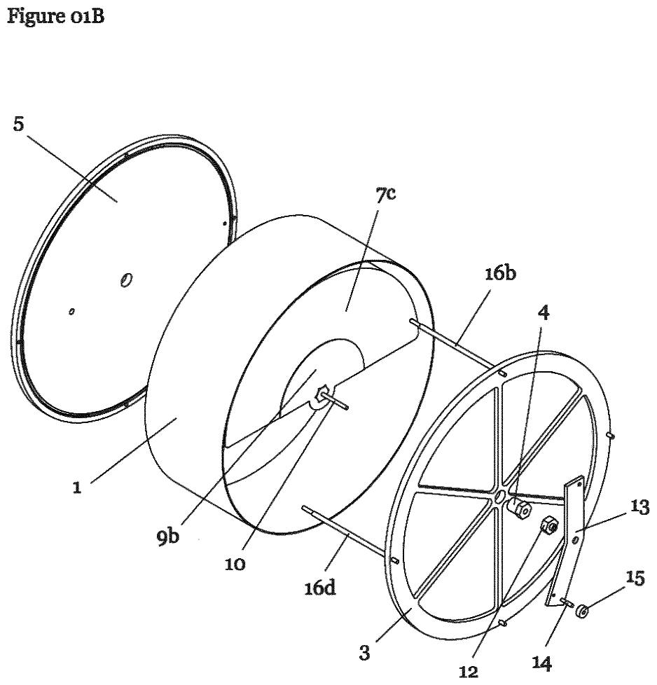

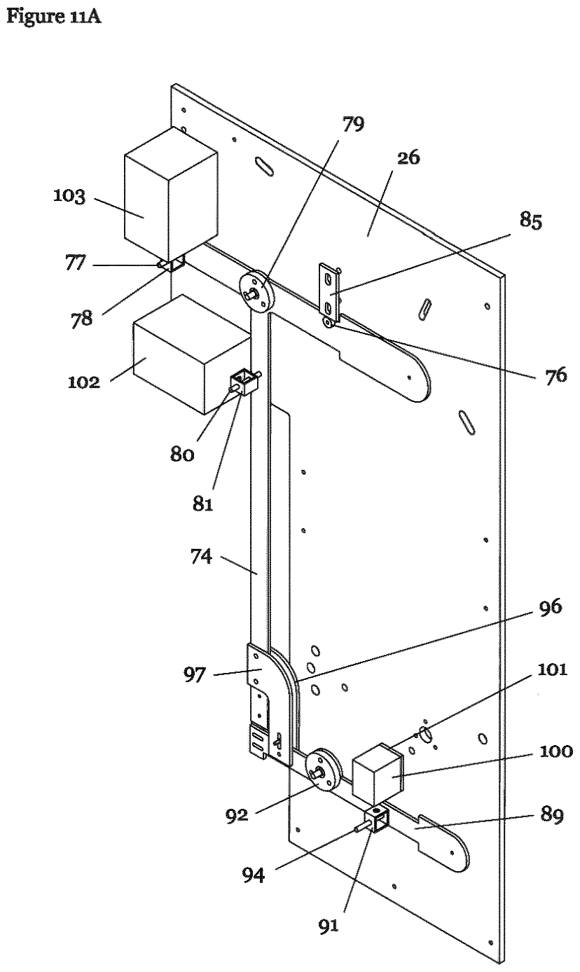

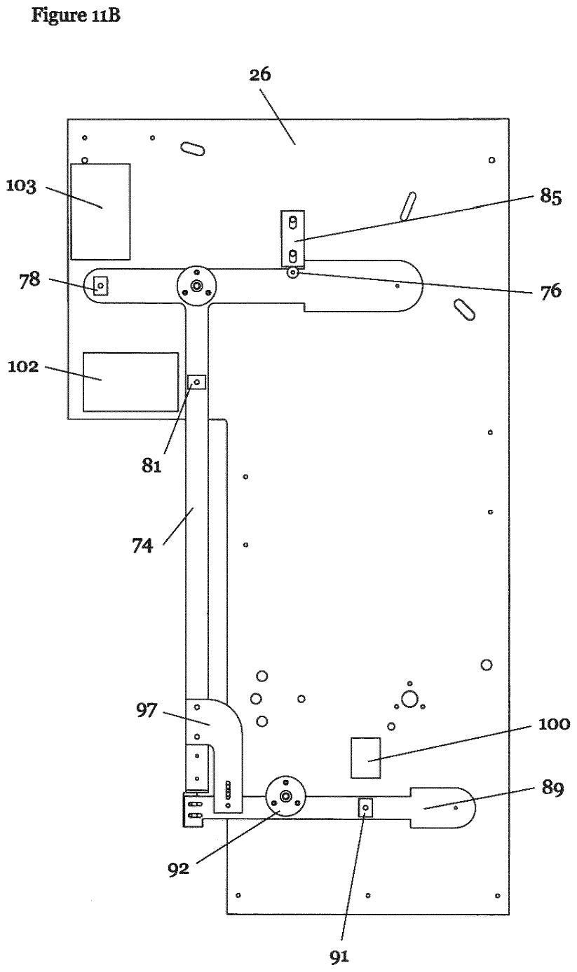

FIGS. 1 to 15 provide an example of how the presently described system may be implemented in an example configuration. However, it is understood that this is purely for illustration and that other configurations may provide the same function as the presently described principles.

For example, in the example of FIGS. 1 to 15, the container is cylindrical and the immersed body is semi cylindrical alternative geometries of both the container and the immersed body may also be used.

In the example of FIGS. 1 to 15, the container is closed and the body is fully immersed within the liquid. However, alternative configurations having alternative geometries may operate in accordance with the presently described mechanisms, such as the container being open (e.g., not closed), and/or the body only partially immersed.

In this following, the density of the immersed body is less than the density of the surrounding fluid which is referred to as a liquid in the below). The immersed body is held to the container in a manner to allow for the body to swing about an axis, thereby enabling the hydrostatic pressure to orientate the body about the axis as appropriate. In addition, an actuator is provided to separately interact with the body such that the body may be made to swing about the axis referred to above.

In the example of FIGS. 1 to 15, the container is located about an axis and connected to that axis by means such that the container with the accompanying liquid and immersed body are able to swing about the axis. The container is such that it may be separated from the mechanism connecting the container to the axis (e.g., the connector). As an alternative, the container and the mechanism by which the container is connected to the axis (e.g., the connector) may be as one integral item.

The elements of FIGS. 1A to 15 will now be described. A summary of the different labelling employed therein is provided at the end of the description. Elements in the Figures that are provided with the same labelling as other elements of other Figures may be treated as the same elements.

As shown in FIG. 1A the containment of the liquid (not shown) is achieved by assembling container using a first plate (5), a cylinder (1), a second plate (3), and first rods (16a, 16b, 16c, 16d) that are configured to extend from the first plate (5) to the second plate (3) through the cylinder (1). The fasteners used to hold the first rods (16a, 16b, 16c, 16d) to the first plate (5) and the second plate (3) are not shown. The first plate (5) shows three holes of which the two smaller holes are used to fill the container with a liquid. The smallest hole in the first plate (5) is used to vent the container of gases or excess liquid, before being subsequently plugged (plug not shown). A first hub (6) plugs the largest hole. The first hub (6) is configured to accept a first shaft (10) that extends through a central portion of the cylinder (1). The first hub (6) is configured to receive the first shaft (10) while permitting the first shaft's free rotation about the first shaft's axis.

As shown in FIG. 1B, the second plate (3) comprises one hole in which a second hub (4) is fitted. The second hub (4) is configured to provide a seal about the first shaft (10) and permit its free rotation about its axis. A first block (12) is fastened to the first shaft (10). Arms (13) are fastened to the first block (12). A second shaft (14) is fastened to the arms (13). In this example, a pointer (15) is held to the second shaft (14). The first pointer (15) is in the form of a roller bearing. In FIG. 1A and FIG. 1B, the liquid is not shown. However, the body that is described below would position itself uppermost as shown by the stiffener (9a, 9b) and the spacer (7a, 7c). In FIG. 1B, one arm of the arms (13) is positioned in the vertical to align with an uppermost position of the body.

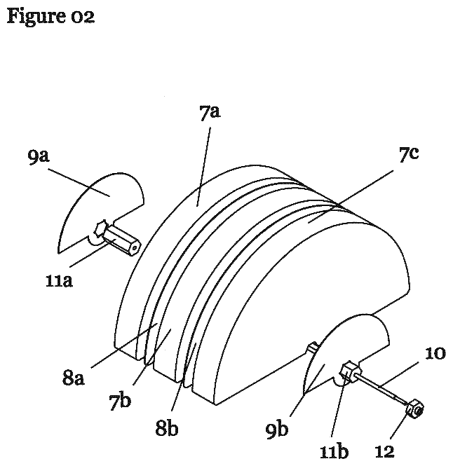

FIG. 2 illustrates a body that comprises stiffeners (9a, 8a, 8b, 9b) and spacers (7a, 7b, 7c). The spacers (7a, 7b, 7c) and stiffeners (9a, 8a, 8b, 9b) are held together to form a singular body. A second block (11a) interlocks with the stiffener (9a, 8a) and a third block (11b) interlocks with stiffeners (8b, 9b). The second and third blocks (11a, 11b) are more generally held to the singular body. The first shaft (10) is fastened to the second and third blocks (11a, 11b) such that rotation of the first shaft (10) about its axis would cause a corresponding rotation of the body.

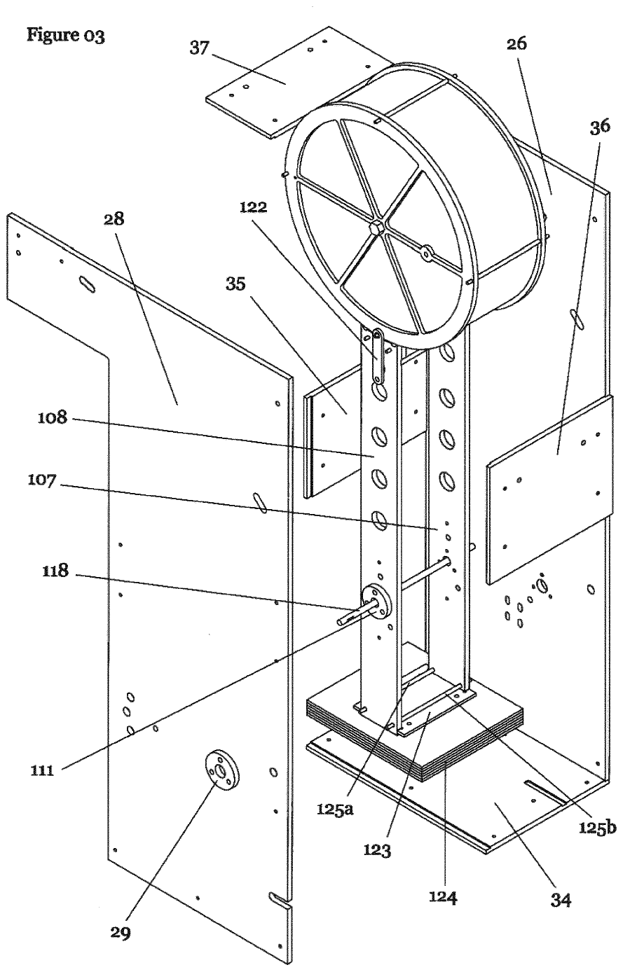

As shown in FIG. 3, in this example panels (28, 26, 37, 35, 36, 34) are fastened together and provide housing to the various elements. A first bearing block (29) is fastened to the panel (28).

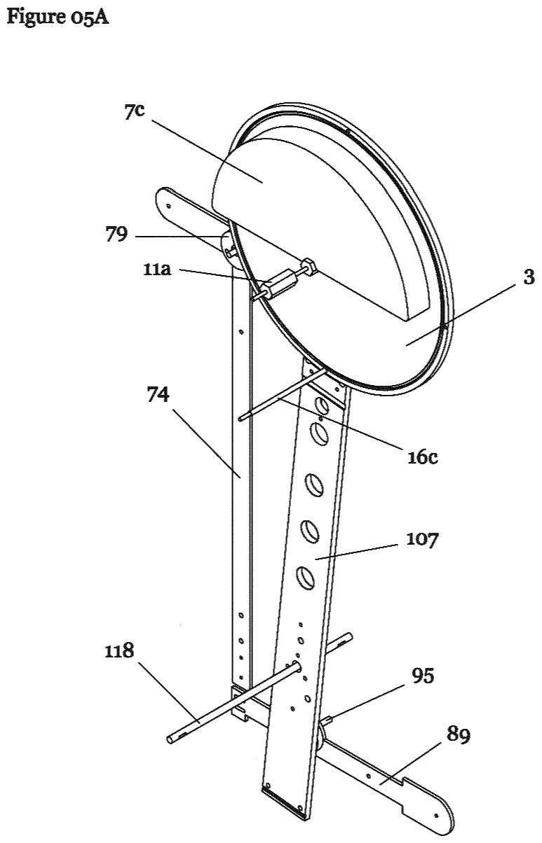

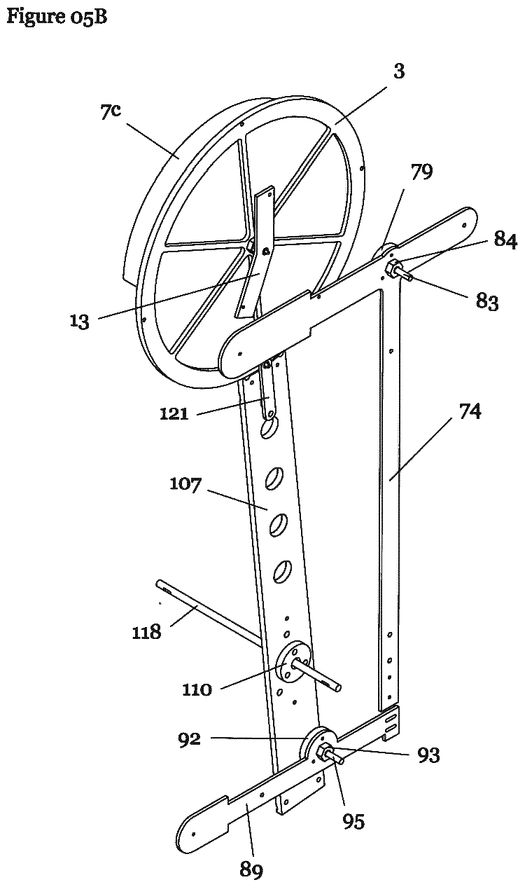

The container as described above is located onto the spokes (108, 107). A first link (122), and a second link (121) (shown in FIG. 5A and FIG. 5B) enable the container to be held to the spokes (108, 107). A second shaft (118) is connected to the panels (28, 26) and provides an axis about which the spokes (108, 107) and the container are free to swing.

A second bearing block (111) and a third bearing block (110) (shown in FIG. 5B) are fastened to the spokes (108, 107) respectively. The second and third bearing blocks (111, 110), in conjunction with their corresponding spokes (108, 107), hold bearings (not shown) that permit the free rotation of the bearings about the second shaft (118). Second rods (125a, 125b) are fastened to the spokes (108, 107). A first connecting plate (123) is held to the spokes (108, 107) by means not shown. The first connecting plate (123) is configured to permit a counter mass (124) to be connected to the spokes (108, 107).

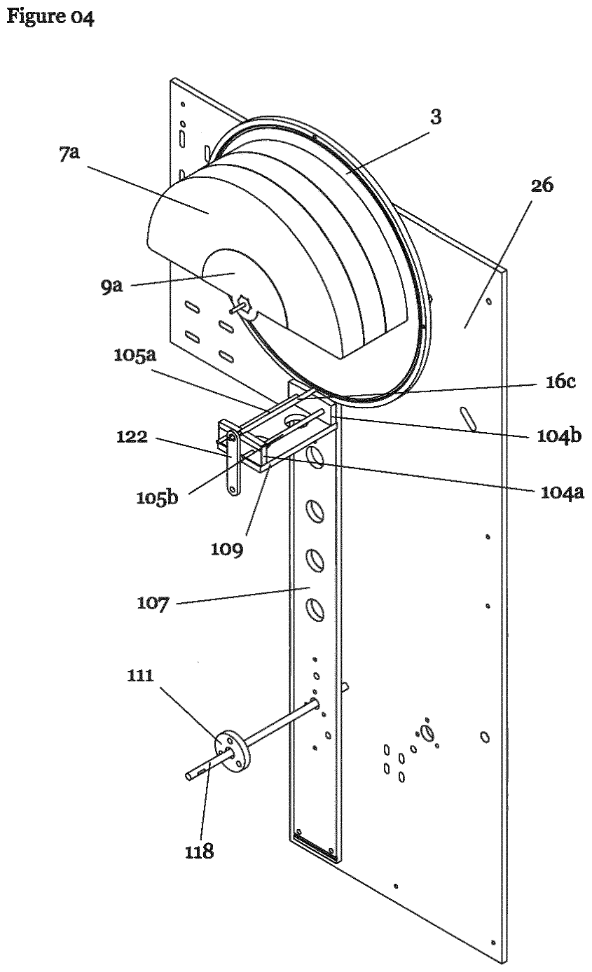

As shown in FIG. 4, in this example third rods (105a, 105b) are fastened to the spoke (107) and spoke (108) (not shown). A second connecting plate (109) is held by means not shown to the spoke (107) and the spoke (108) (not shown). A first guide (104b) is fastened to the spoke (107) via the third rods (105a, 105b) and a second guide (104a) is fastened to the spoke (108) (not shown) via the third rods (105a, 105b). The first and second guides (104a, 104b) accept the first rod (16c) and the plate (3) bears upon the spoke (107). Similarly the plate, (5) would bear upon the spoke (108) (not shown).

As shown in FIG. 5A, in this example the third shaft (95) is fastened to the panel (26) (not shown). A first actuator (89) is free to swing about the axis of the third shaft (95). A third bearing block (79) is fastened to a second actuator (74).

As shown in FIG. 5B, in this example a fourth shaft (83) is fastened by means not shown to the panel (26) not shown. A spacer (84) is situated about the fourth shaft (83) and between the second actuator (74) and the panel (26) (not shown). The fourth bearing block (92) is fastened to the first actuator (89). A spacer (93) is situated about the third shaft (95) and between the first actuator (89) and the panel (26) (not shown).

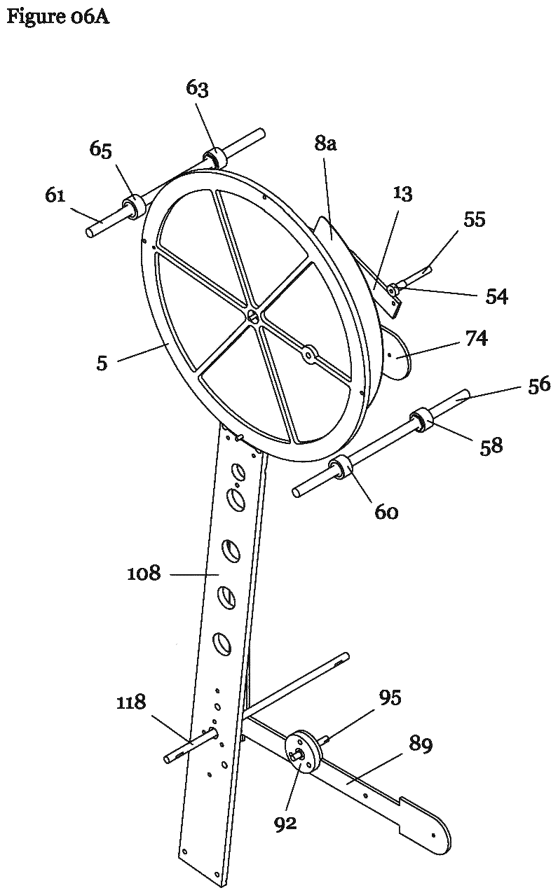

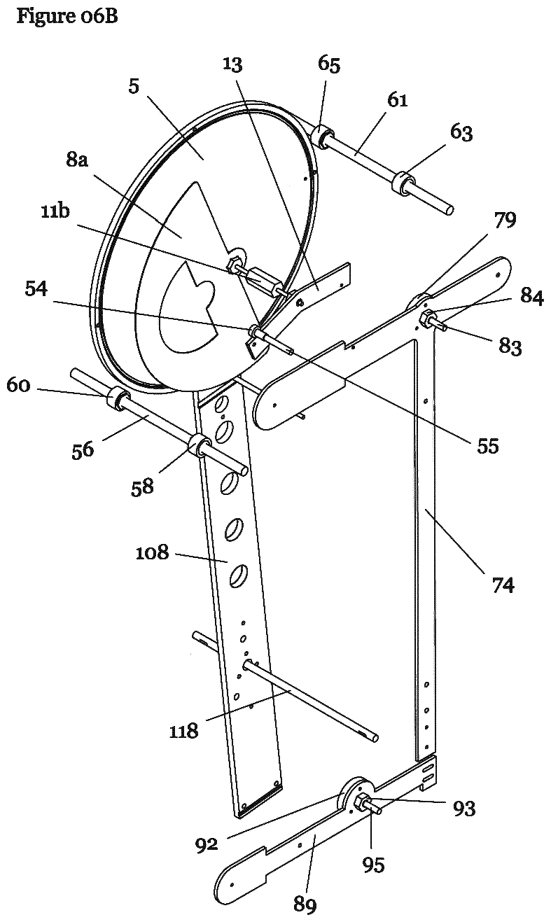

As shown in FIG. 6A, in this example bars (61, 56) are fastened to the panels (28, 26) (not shown). A fifth shaft (55) is fastened to the panel (26) (not shown). In this example, the swing of the container as referred to above is limited due to stops (65, 60, 63, 58) that are situated along the bars (61, 56) to align with the plate (5) and the plate (3) (not shown). A second pointer (54) is situated onto the shaft (55) such that the second pointer would be aligned with the arms (13). In this example, the second pointer (54) is in the form of a roller bearing.

As shown in FIG. 6B, in this example the body is located within the container such that the arm (13) would be inclined to keep contact with the second pointer (54) due to the hydrostatic pressure onto the body. Stated differently, the body is located within the container such that the arm (13) is biased to contact second pointer (54). The biasing may be achieved via hydrostatic pressure on the body.

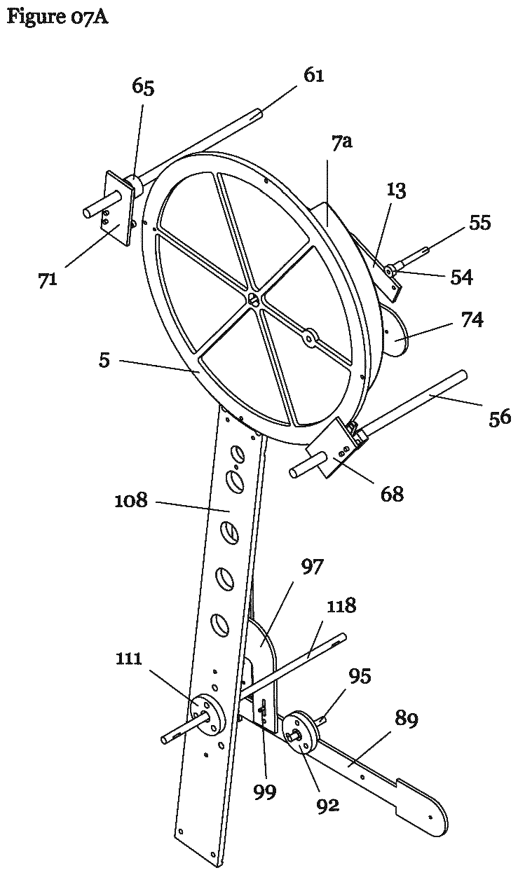

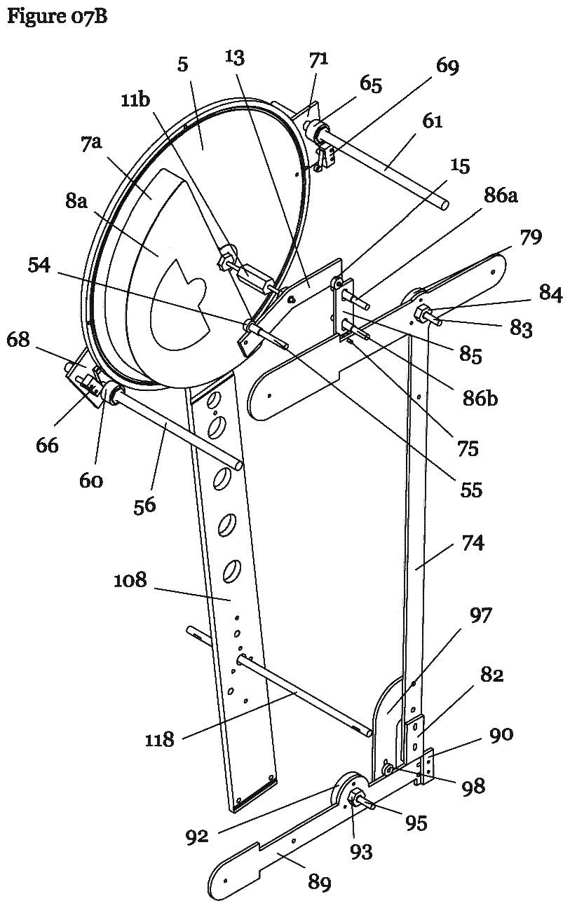

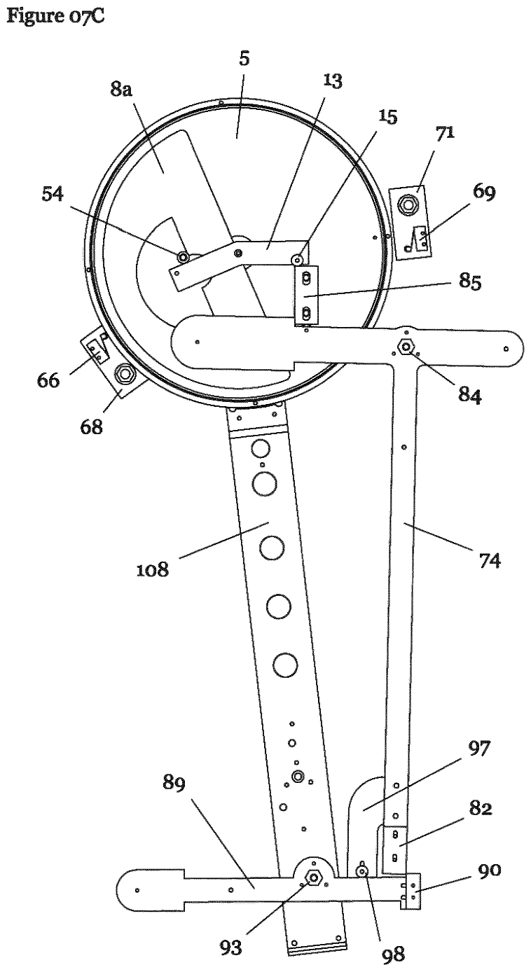

As shown in FIG. 7A, in this example mounts (71, 68) are fastened to the bars (61, 56) respectively. A sixth shaft (99) is connected to a third guide (97).

As shown in FIG. 7B in this example the third guide (97) is fastened to the second actuator (74). The first roller (98) is situated on the sixth shaft (99) (not shown). The first roller (98) comprises a roller bearing. A first catch (82) is fastened to the second actuator (74). A second catch (90) is fastened to the first actuator (89).

First and second micro switches (69, 66) are connected to the mounts (71, 68) respectively. In this example, the first and second micro switches (69, 66) are in the form of micro switches. The first and second micro switches (69, 66) are situated such that they are aligned with the plate (5).

A seventh shaft (75) is fastened to the second actuator (74). Fourth and fifth guides (86a, 86b) are fastened to the panel (26) (not shown). A follower (85) is held to the guides (86a, 86b) by and held from the panel (26) (not shown).

As shown in FIG. 7C, in this example a first pointer (15) is fastened to the arms (13) such that the first pointer (15) is aligned with the follower (85). In this example, the first pointer (15) is in the form of a roller bearing.

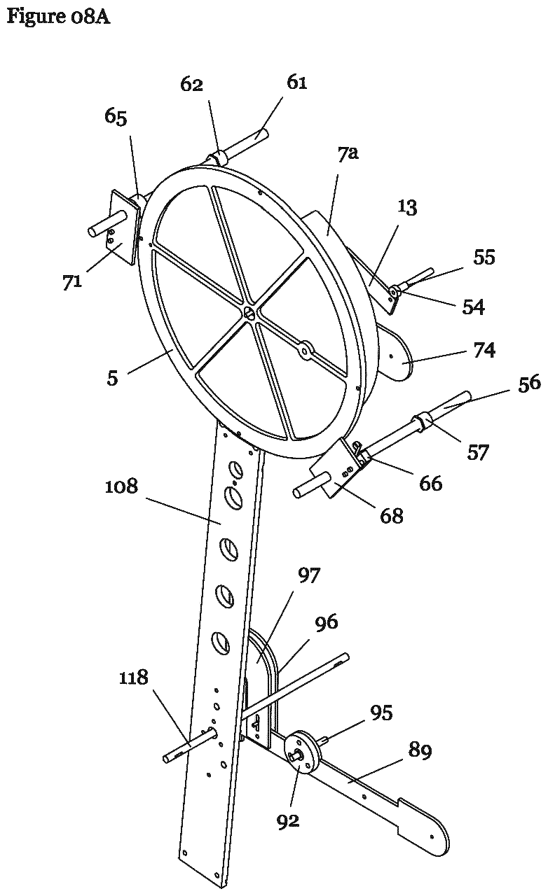

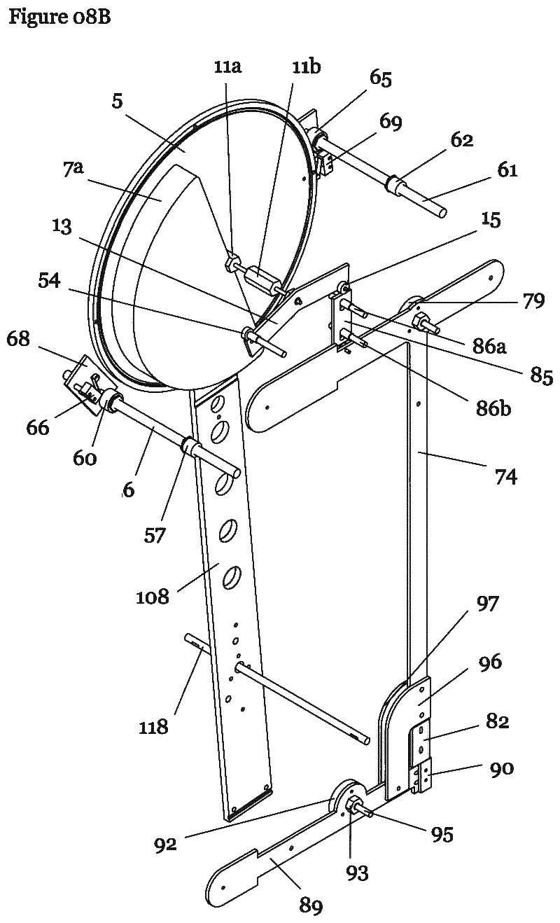

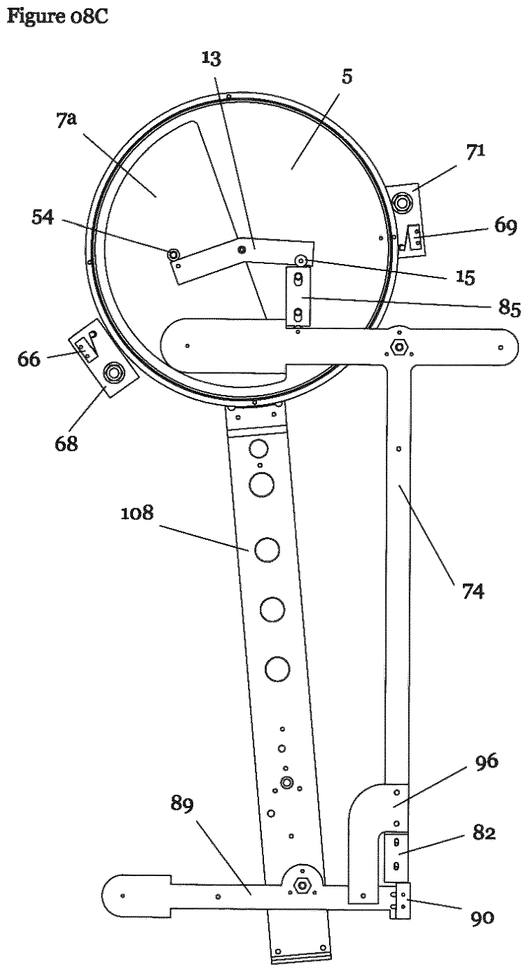

As shown in FIG. 8A, in this example sixth guide (96) is fastened to the second actuator (74). In this example, the stops (65, 60, 63, 58) (as shown in FIG. 6A) comprise a tyre and carriers (62, 57). The carriers (62, 57) may correspond to the stops (63, 58) respectively.

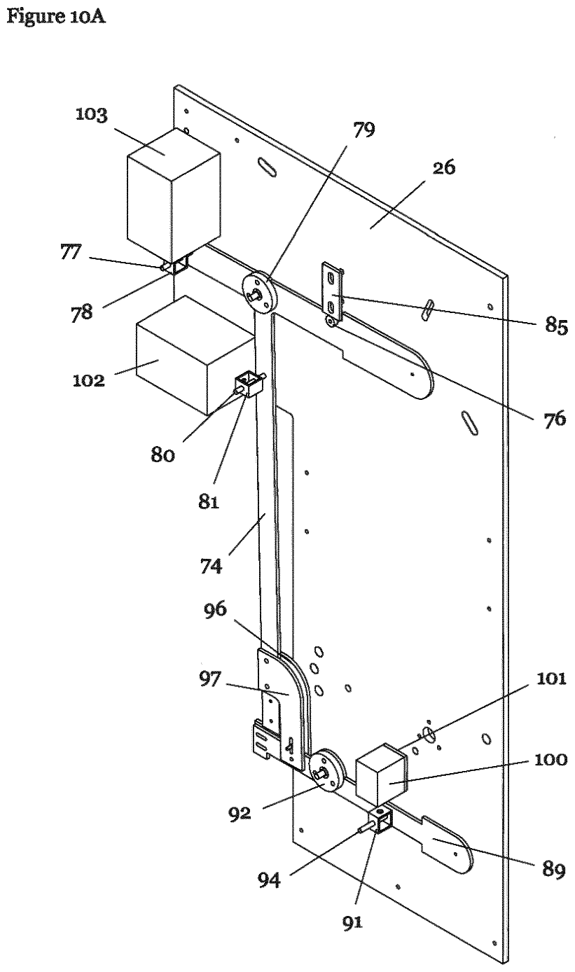

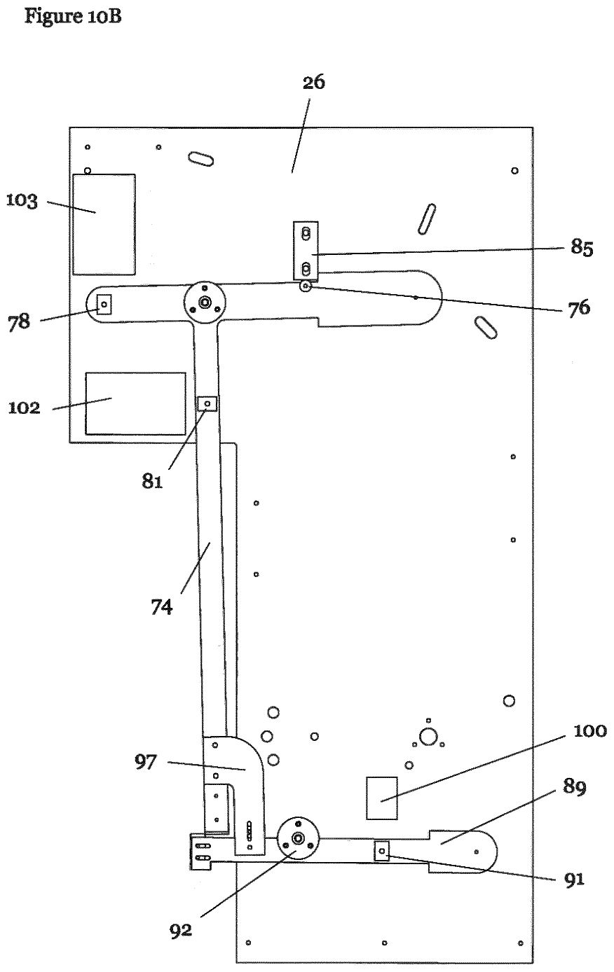

As shown in FIG. 10A in this example a third pointer (76) is held to the seventh shaft (75) (not shown) such that the third pointer (76) is aligned to the follower (85). In this example the third pointer (76) is in the form of a roller bearing. Solenoids (103, 102, 100) are fastened to the panel (26). An offset (101) is held to the solenoid (100). In this example the solenoids (103, 102, 100) are adapted to permit plungers (not shown) to connect with shoes (78, 81, 91) respectively. The shoes (78, 81) are situated onto fourth and fifth rods (77, 80) respectively. The fourth and fifth rods (77, 80) are fastened to the second actuator (74). The shoe (91) is situated onto a sixth rod (94). The sixth rod (94) is fastened to the first actuator (89).

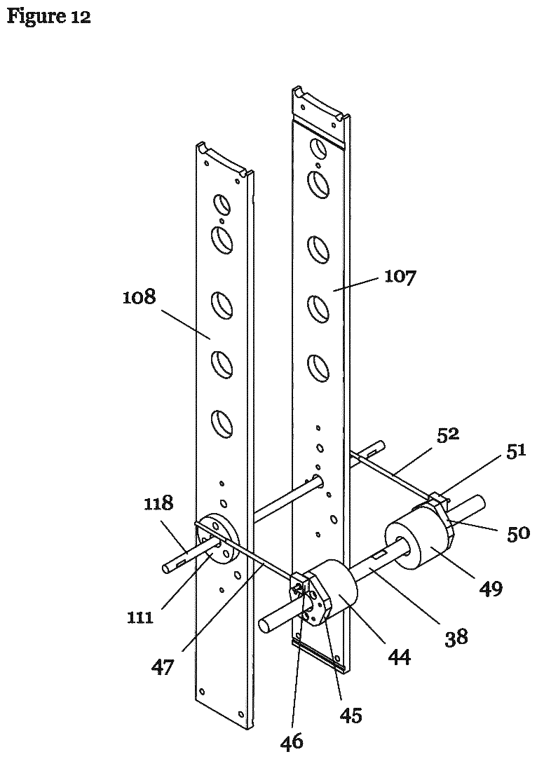

As shown in FIG. 12, in this example, an eighth shaft (38) is held to the panels (28, 26) (not shown) such that the eighth shaft (38) is free to rotate about its axis. Collars (44, 49) are fitted with roller clutch bearings not shown. Fourth blocks (45, 50) are respectively fastened to the collars (44, 49). Third and fourth links (47, 52) are fastened at one of their ends to the caps (46, 51) respectively.

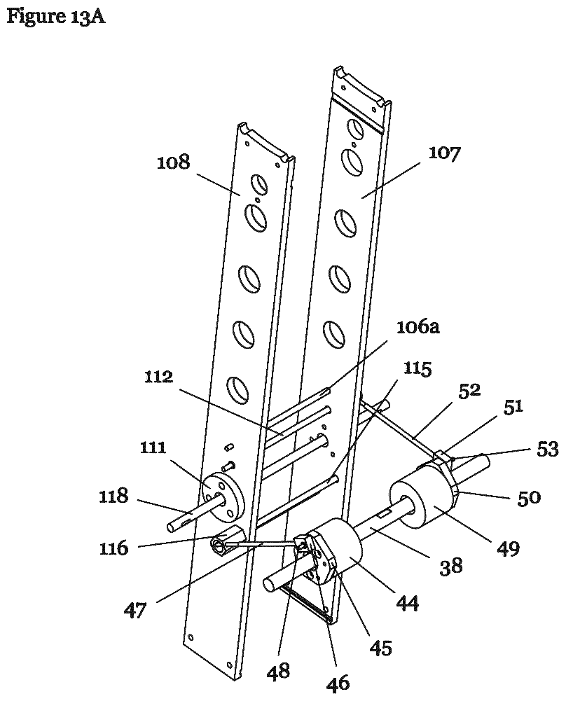

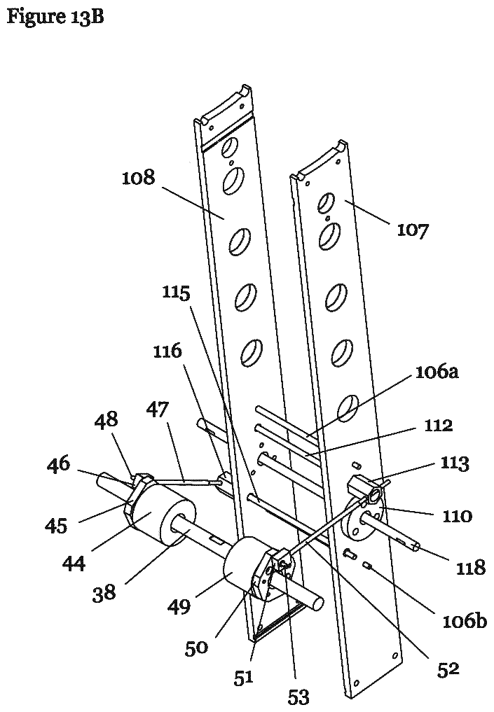

As shown in FIG. 13A in this example the third link (47) is held to fifth block (116). The fifth block (116) is fastened to the ninth shaft (115). The ninth shaft (115) is held to spokes (108, 107) such that the ninth shaft (115) would be free to rotate about its axis. The first pin (48) is fastened to the fourth block (45). The cap (46) is held to the first pin (48) such that the cap (46) would be free to rotate about the axis of the first pin (48). A tenth shaft (112) is held to spokes (108, 107) such that the tenth shaft (112) would be free to rotate about its axis. A first tie rod (106a) is fastened at its respective ends to the spokes (108, 107).

As shown in FIG. 13B, in this example, a second tie rod (106b) is fastened at its respective ends to the spokes (108, 107). A sixth block (113) is fastened to the tenth shaft (112). A second pin (53) is fastened to the fourth block (50). The cap (51) is held to the second pin (53) such that the cap (51) would be free to rotate about the axis of the second pin (53).

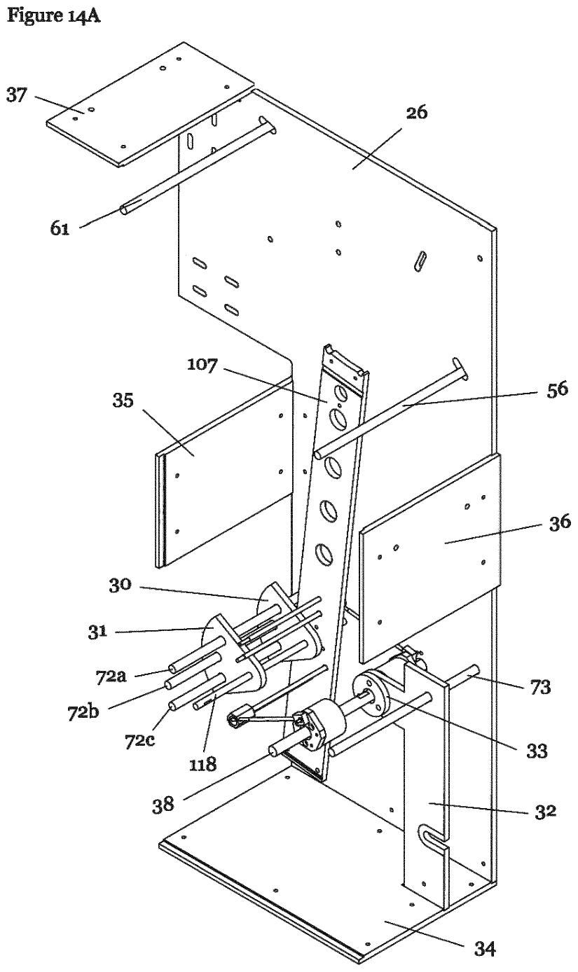

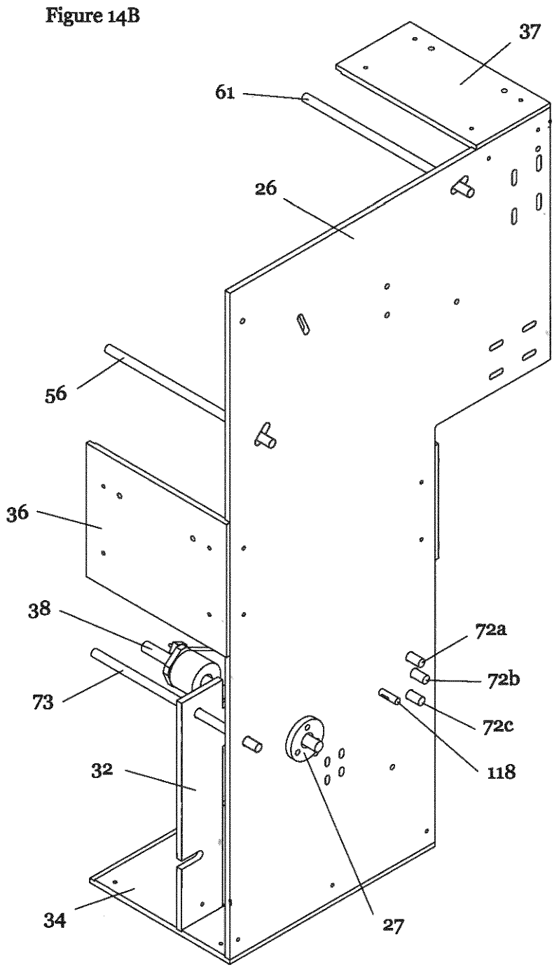

As shown in FIG. 14A, in this example, the panels (28, 26, 37, 35, 36, 34) are fastened together. A first support (32) is fastened to the panel (34). A fifth bearing block (33) is fastened to the first support (32). Second bar (73) is fastened to the panel (26), the first support (32), and the panel (28) (not shown). The bars (72a, 72b, 72c) are fastened by means not shown to the panel (26) and the panel (28) not shown. The mounts (31, 30) are fastened by means not shown to the bars (72a, 72b, 72c). The second shaft (118) is held to mounts (31, 30).

As shown in FIG. 14B, in this example, a sixth bearing block (27) is fastened to the panel (26).

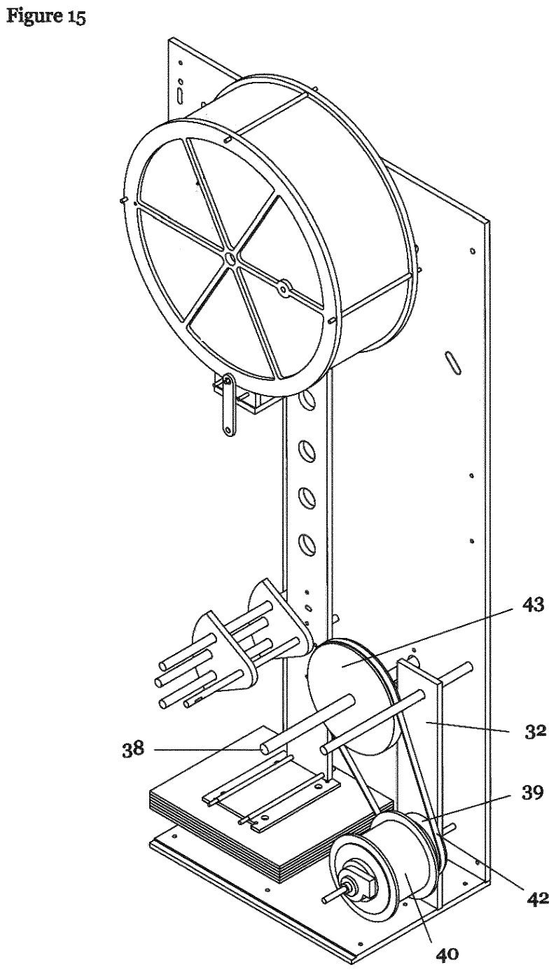

As shown in FIG. 15 in this example a first pulley (43) is fastened to the eighth shaft (38). The first pulley (43) is in the form of a timing pulley. An electric generator (40) is fastened to the first support (32) and the panel (28) (not shown). In this example, the electric generator (40) is in the form of a bicycle hub dynamo. A second pulley (39) is fastened to the electric generator (40). The second pulley (39) is in the form of a timing pulley that has been modified to mount onto the electric generator (40). A belt (42) connects the first pulley (43) to the second pulley (39) in this example, the belt (42) is in the form of a timing belt.

The operation of the presently described system will now be described with reference to the example of the above-mentioned Figures.

As shown in FIG. 3, the spokes (108, 107) are aligned in the vertical. This vertical alignment may occur when the arms (13) are not in contact with the second pointer (54), or when the first pointer (15) is not in contact with the follower (85), and the stops (65, 60, 63, 58) are not present.

In such an instance, the body as referred to above would also be aligned in the vertical, such as shown in FIG. 1A. The body would be aligned in the vertical due to the hydrostatic pressure of the liquid on the body within the container. In this example the centre of mass of the combined mass of all the items connected to the spokes (108, 107) would coincide with the axis of the second shaft (118) if the liquid were not present and contained within the container. By extension, if the container were entirely removed from the spokes (108, 107), the centre of mass of that remaining structure would be vertically below the axis of the second shaft (118).

During operation, the container and the attached spokes (108, 107) are moved within a few degrees clockwise and/or anticlockwise of the vertical position illustrated in FIG. 4. For example, when the container and the attached spokes are moved (e.g., rotated) a few degrees clockwise of the vertical position adopted in FIG. 4, then the spokes and container may be in the position implicit from FIGS. 6A and 6B.

As shown in FIG. 6A, the body in FIG. 6A is located significantly more than 90 degrees clockwise of the vertical position illustrated in FIG. 4. In this orientation, as shown in FIG. 6A, the second pointer (54) is in contact with the arms (13) as a result of the hydrostatic pressure to the body within the container seeking to return the body to a vertical position. In this arrangement, the upthrust to the body combined with a reaction to the arms (13) provided via the second pointer (54) produces a resultant force to the container via the first shaft (10). The resultant force acts to cause the container (and attached spokes (108, 107), etc.) to swing towards the bar (61). Since the container and the attached spokes (108, 107) are located only a few degrees clockwise of the vertical position adopted in FIG. 4, the effect of the hydrostatic pressure to the cylinder (1) is insufficient to overwhelm the resultant force and thus insufficient to prevent the container's swing towards the bar (61).

When the container arrives at the limits of the bar (61) (as represented in FIG. 8B) the follower (85) is raised by movement of the first and second actuators. In the present example (as is discussed in more detail below), the first and second actuators may be caused to move by the action of at least one solenoid controlling motion of a plunger that is configured to move the first and/or second actuator. This process is illustrated in more detail below. The effect of raising the follower is to disconnect the arms (13) from its contact with the second pointer (54), thereby removing the resultant force via the first shaft (10) and to connect the first pointer (15) with the horizontal surface of the follower (85).

This new contact between the first pointer (15) and the horizontal surface of the follower (85) provides a new reaction force that is directed in a vertical plane to counter the upthrust to the body. This leaves the hydrostatic pressure to the cylinder (1) (which will be referred to as the downthrust) to cause the container (and spokes, etc.) to swing towards the bar (56). With the follower (85) raised, the first pointer (15) is free to roll along the horizontal surface of the follower (85).

When the container arrives at its limits at the bar (56) as represented in FIG. 7B the follower (85) is lowered by means described below, the effect of this is to disconnect the first pointer (15) from its contact with the follower (85) and connect the second pointer (54) with the arms (13). With the arms (13) again in contact with the second pointer (54), the container (and connected spokes) is made to swing towards the bar (61). The above process may be repeated continuously as the follower is raised and lowered (e.g., moved between a first and second position).

The following provides more information on how the first and second actuator may be configured to cause the follower (85) to change position in the example of the Figures.

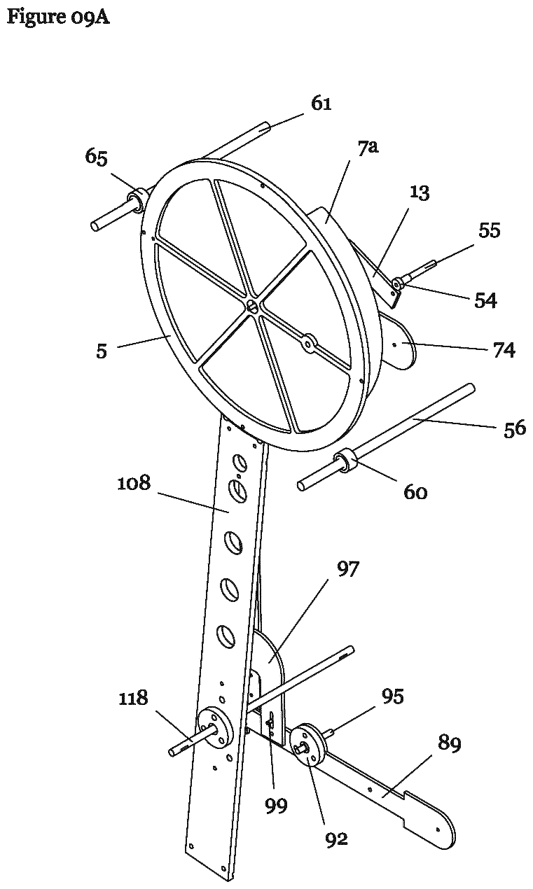

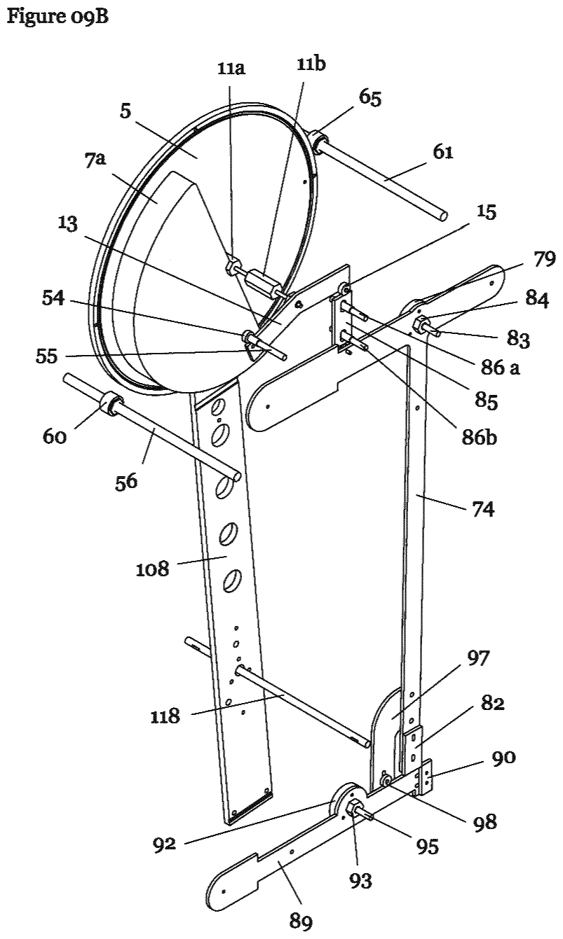

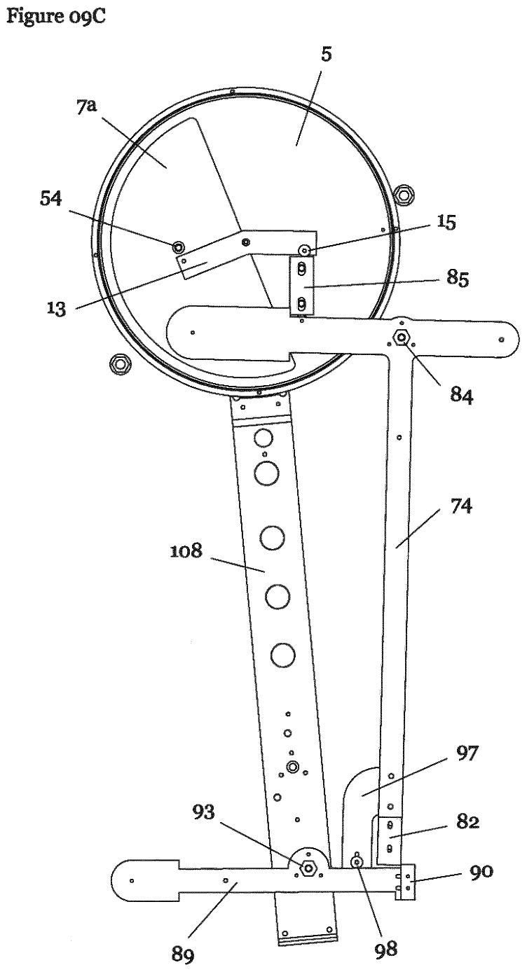

With reference to FIG. 10A, the follower (85) may be raised by causing the second actuator (74) (and thus the third pointer (76)) to swing anticlockwise to an extent that the first actuator (89) swings (e.g., moves) such that the second catch (90) interlocks with the first catch (82). This is illustrated in the example of FIGS. 9A to 9C, particularly FIG. 9C.

The first actuator (89) may remain as shown in FIG. 9C due to the centre of mass of the first actuator (89) being toward the opposite end to the second catch (90) (relative to the axis about which the first actuator (89) is able to swing). By causing the first actuator (89) to subsequently swing in the opposing direction to the initial movement, the interlocking of the first and second catches (90, 82) would cease and the second actuator (74) would subsequently resume a position as shown in FIG. 5B.

The solenoids (103, 102) cause the plungers (not shown) to move a set distance in a direction toward the shoes (78, 81) respectively when operated. The plungers (not shown) may be adjusted such that they are at the limits of their range of travel and in contact with the shoes (78, 81) when the second actuator (74) is in the position as shown in FIG. 5B and in FIG. 9C. By operating the solenoids (103, 102), the second actuator (74) is caused to swing (e.g., move about an axis) and thereby raise the follower (85).

The second actuator (74), if not otherwise prevented from so doing, is biased to assume the position as shown in FIG. 5B due to the centre of mass of the second actuator (74) being toward the opposite end to the solenoid (103) relative to the axis about which the second actuator (74) is able to swing. The solenoid (100), when operated, causes the plunger (not shown) associated with that solenoid to move a set distance in a direction away from the shoe (91). Operating the solenoid (100) therefore causes the first actuator (89) to swing about an axis, which removes the interlocking of the first and second catches (90, 82). Stated differently, the solenoid is configured to cause the first actuator to move such that the first and second catches move from a locking orientation to an unlocked orientation. Further, this movement of the first actuator causes the second actuator (74) to resume the position shown in FIG. 5B, which causes the follower (85) to lower (e.g., be moved to a second position, where the raised position (mentioned above) is a first position).

In this example the solenoids (103, 102, 100) are operated in conjunction with the first and second micro switches (69, 66), and a microcontroller (not shown).

In general, the microcontroller (not shown) may be programmed to operate the solenoids (103, 102) for a duration that is sufficient to swing the second actuator (74) to such an extent that the first and second catches (90, 82) would interlock when the plate (5) contacts the first micro switch (69).

The microcontroller (not shown) may also be programmed to operate the solenoid (100) for the duration sufficient to swing the first actuator (89) to such an extent that the first and second catches (90, 82) would no longer be interlocked, when the plate (5) contacts the second micro switch (66).

The following describes how, in relation to the example of the Figures, the movement of the container (discussed above) may be harnessed to provide an output force to an output shaft. The output shaft may be configured to provide an input to a motor and/or a generator.

With reference to FIG. 13B, in this example, the container and therefore the spokes (108, 107) would swing back and forth repeatedly above a rotation point (e.g., about second shaft 118). This may further cause, via the third and fourth links (47, 52), the collars (44, 49) to rotate back and forth about the axis of the eighth shaft (38) repeatedly, as these components are connected.

By arranging the roller clutch bearing (not shown) within the collars (44, 49) appropriately, the eighth shaft (38) may be made to rotate an increment in one direction as the spokes (108, 107) swings back (e.g., moves in a first direction about the axis) and made to rotate an increment in the same direction when the spokes (108, 107) swings forth (e.g., moves in a second direction about the axis, the first direction being opposite to the second direction).

Therefore, the back and forth motion of the container may cause the eighth shaft (38) to rotate in one continuous direction. As would be understood from FIG. 15 the rotation of the eighth shaft (38) may cause the rotation of the electric generator (40).

The foregoing description has provided, by way of non-limiting examples, a full and informative description of the exemplary example of this disclosure. However, various modifications and adaptions may become apparent to those skilled in the relevant art in view of the foregoing description, when read in conjunction with the accompanying drawings and the appended claims. However, all such and similar modifications of the teachings of this disclosure will still fall within the scope of the invention as defined in the appended claims. Indeed, there is a further example comprising a combination of one or more examples with any of the other examples previously discussed.

List of Labelling

| | |
|---|---|
| 1 | cylinder |
| 3 | plate |
| 4 | second hub |
| 5 | plate |
| 6 | first hub |
| 7a | spacer |
| 7c | spacer |
| 8a | stiffener |
| 8b | stiffener |
| 9a | stiffener |
| 9b | stiffener |
| 10 | first shaft |
| 11a | second block |
| 11b | third block |
| 12 | first block |
| 13 | arms |
| 15 | first pointer |
| 16a | first rods |
| 16b | first rods |
| 16c | first rods |
| 16d | first rods |
| 26 | panel |
| 27 | sixth bearing block |
| 28 | panel |
| 29 | first bearing block |
| 30 | mounts |
| 31 | mounts |
| 32 | first support |
| 33 | fifth bearing block |
| 34 | panel |
| 35 | panel |
| 36 | panel |
| 37 | panel |
| 38 | eighth shaft |
| 39 | second pulley |
| 40 | electric generator |
| 42 | belt |
| 43 | first pulley |
| 44 | collar |
| 45 | fourth block |
| 46 | cap |
| 47 | third link |
| 48 | first pin |
| 49 | collar |
| 50 | fourth block |
| 51 | cap |
| 52 | fourth link |
| 53 | second pin |
| 54 | second pointer |
| 55 | fifth shaft |
| 56 | bars |
| 57 | carriers |
| 58 | stop |
| 60 | stop |
| 61 | bars |
| 62 | carriers |
| 63 | stop |
| 65 | stop |
| 66 | second micro switch |
| 68 | mounts |
| 69 | first micro switch |
| 71 | mounts |
| 72a | third bars |
| 72b | third bars |
| 72c | third bars |
| 73 | Second bar |
| 74 | second actuator |
| 75 | seventh shaft |
| 76 | third pointer |
| 77 | fourth rod |
| 78 | shoe |
| 79 | third bearing block |
| 80 | fifth rod |
| 81 | shoe |
| 82 | first catch |
| 83 | fourth shaft |
| 84 | spacer |
| 85 | follower |
| 86a | Fourth guide |
| 86b | fifth guide |
| 89 | first actuator |
| 90 | second catch |
| 91 | shoe |
| 92 | fourth bearing block |
| 93 | spacer |
| 94 | sixth rod |
| 95 | third shaft |
| 96 | sixth guide |
| 97 | third guide |
| 98 | first roller |
| 99 | sixth shaft |
| 100 | solenoid |
| 101 | offset |
| 102 | solenoid |
| 103 | solenoid |
| 104a | first guide |
| 104b | second guide |
| 105a | third rods |
| 105b | third rods |
| 106a | first tie rod |
| 106b | second tie rod |
| 107 | spoke |
| 108 | spoke |
| 109 | second connecting plate |
| 110 | third bearing blocks |
| 111 | second bearing block |
| 112 | tenth shaft |
| 113 | sixth block |
| 115 | ninth shaft |
| 116 | fifth block |
| 118 | second shaft |
| 121 | second link |
| 122 | first link |
| 123 | First connecting plate |
| 124 | counter mass |
| 125a | second rods |
| 125b | second rods |

1. An apparatus comprising:
a container housing a body immersed in a fluid;
at least one actuator configured to cause the body to move within the fluid to deflect about an equilibrium position of the body within the fluid, wherein when the body is not at its equilibrium position, hydrostatic pressure from the fluid acts to cause the body to return to its equilibrium position; and
at least one connector connecting the container to an output shaft;
wherein when the hydrostatic pressure is acting to cause the body to return to its equilibrium position, the container and the at least one connector are caused to at least partially rotate about an axis, wherein the at least partial rotation causes the output shaft to rotate.

2. The apparatus as claimed in claim 1, wherein the apparatus comprises at least one solenoid that controls a respective plunger to move between an initial position and an extended position, wherein movement of the respective plunger between its initial position and its extended position causes the at least one actuator to move to cause the body to move within the fluid to deflect about the equilibrium position.

3. The apparatus as claimed in claim 1, wherein the at least one actuator comprises:
a first actuator; and
a second actuator connected to the first actuator such that the first actuator is able to linearly move towards and away from the second actuator.

4. The apparatus as claimed in claim 15, wherein the first actuator is associated with first and second solenoids configured to move the first actuator linearly towards and away from the second actuator in different, perpendicular, directions.

5. The apparatus as claimed in claim 4, wherein the second actuator is associated with a third solenoid configured to move the second actuator.

6. The apparatus as claimed in claim 1, wherein the body has a lower density than the fluid.

7. The apparatus as claimed in claim 1, wherein the connector comprises first and second spokes.

8. The apparatus as claimed in claim 1, wherein the apparatus further comprises:
at least one link that connects the connector to the output shaft, such that a back-and-forth motion of the at least one link causes the output shaft to rotate in a single direction.

9. The apparatus as claimed in claim 1, wherein the apparatus further comprises:
an arm configured to constrained to rotate between a first position and a second position.

10. The apparatus as claimed in claim 9, wherein the apparatus further comprises a first stop located near a first side of the arm, and a second stop located near a second side of the arm, wherein the arm is configured to contact the first stop when the arm is located at the first position and to contact the second stop when the arm is located at the second position.

11. The apparatus as claimed in claim 9, wherein the apparatus further comprises a follower that transfers a motion of the actuator to a motion of the arm, such that when the actuator moves, the arm is caused to move between the first position and the second position.

12. The apparatus as claimed in claim 9, wherein the rotation of the arm between the first position and the second position causes the body to deflect about the equilibrium position.

13. A generator configured to:
receive a rotational input from the output shaft of the apparatus according to claim 1; and
convert the received rotational input into electrical energy.

14. A method of using an apparatus according to claim 1, the method comprising:
moving, by the at least one actuator, the body within the fluid to cause the body to deflect about the equilibrium position;
rotating the connector and the container about the axis by the hydrostatic pressure of the fluid causing to return the body to an equilibrium position; and
converting the rotation of the connector about the axis into a rotation of the output shaft.

15. The apparatus as claimed in claim 2, wherein the at least one actuator comprises:
a first actuator; and
a second actuator connected to the first actuator such that the first actuator is able to linearly move towards and away from the second actuator.
